(19) United States
(12) Patent Application Publication
(10) Pub. No.: US 2007/0036687 A1
(43) Pub. Date: Feb. 15, 2007

(54) Sample tube

(76) Inventors: Peter William Woods, Cambridgeshire (GB); Timothy Mark Beggs, Hertfordshire (GB); Stephen Guy, Hertfordshire (GB); Richard Wales, Cambridgeshire (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/493,030

(22) Filed: Jul. 26, 2006

(30) Foreign Application Priority Data
Jul. 27, 2005 (GB) 0515426.5

(51) Int. Cl. B01L 3/00

(52) U.S. Cl. 422/102

(57) ABSTRACT

A sample tube 1 is provided for insertion, in use, into an SBS format rack. The sample tube comprises a polypropylene body 11 with an internal metal coating 3 and a glass lining or coating 2 disposed on the metal coating.

### BACKGROUND

The present invention relates to sample tubes and, more particularly, to sample tubes for use in sample management and screening systems, for example such as used in drug discovery processes or other chemical or biological processes.

Conventionally, in drug discovery processes and the like, multi-well micro-titre plates (or often simply “microplates”) have been used for sample storage. Such plates contain a large number of wells, for example, 96 or 384 individual wells. The SBS format standard plates are well known in the industry. However, with the growing need to avoid sample wastage SBS format plates with as many as 1536 wells have been introduced.

In 2003, The Automation Partnership introduced its PicoTube™, for storage at a very high density in 384-SBS format racks, allowing processing just like 384 well micro-titre plates. Such PicoTubes™ are formed from polypropylene and have a total volume of about 100 μl and using appropriate picking robots, systems can maintain high storage and throughput.

It has been known to use such “microplates” or the like formed from glass or glass-lined in order to provide, for example, required chemical resistance or to avoid the need for the use of polystyrene or polypropylene microplates in certain pharmaceutical applications.

EP-A-1 550 853 discloses a micro-titre plate having a plurality of wells coated with a silicon dioxide layer. Additionally it shows the use of an inorganic metal adhesive for bonding individual cylindrical members to a supporting plate to form a micro-titre plate and the use of an inorganic adhesive to bond together preformed vessels into a supporting base plate. GB-A-2 334 954 shows glass vials for use in a microplate.

### SUMMARY OF THE INVENTION

According to the present invention a sample tube for insertion in use into an SBS format or similar rack comprises:
a polypropylene body;
a metallic coating on the internal surface of the tube; and
a glass coating or lining layer bonded to the metal coating.

Such a sample tube is distinguished over the art referred to above (a) by providing individual tubes for insertion into a rack and (b) by the provision of a metal layer between the walls of the tube and the glass coating or lining.

Both the metal an glass coatings or layers may be provided by a glass sputtering process or a plasma deposition process. The metal coating is preferably aluminium. It provides not only opaqueness to ultra-violet (UV) and visible light, but also a convenient way to heat or control the rate of heating or cooling of a sample within the tube as the metal coating enhances heat transfer. In some chemical or biological processes samples are moved between different stages at which they are either heated to a desired temperature or cooled to a desired temperature. However, it may also be desired to control the rate of cooling or heating and the application of heat through the metal layer may usefully provide the necessary control.

The glass provides appropriate chemical resistance and inertness whilst additionally preventing gaseous exchange between the polypropylene body and a sample compound disposed within the tube.

Additionally, glass provides for reduced “wetting” reducing the likelihood of drops of compound adhering to the sides of the tube rather than falling to the bottom of the tube. This can be important when (if) checking of tube contents is required in a given process.

A further advantage arises if the glass is made to be either opaque or amber which is addition reduction of UV and visible light falling on the contents of the sample tube, reducing the potential for photolysis.

The metal coating may also be useful in processes which involve the use of capacitance type volume/level sensing of fluid samples within the tubes.

The sample tube may include a metal tag connected to or integrally formed with the metal coating and extending through the wall of the sample tube to the exterior.

The invention also includes a chemical or biological process using a sample tube according to the invention, wherein a chemical or biological sample is disposed in the sample tube and heat is applied to the tube either to control either the rate of heating the sample or to slow the rate of cooling of the sample when the tube is being either heated or cooled respectively.

The sample tube may also be pre-heated in a similar manner before a sample is inserted into it.

### BRIEF DESCRIPTION OF THE DRAWINGS

Two examples of sample tubes according to the present invention will now be described with reference to the accompanying drawings, in which:

FIG. 1 is a longitudinal section through a first sample tube shown held within part of an SMS-format rack; and

FIG. 2 is a longitudinal section through a second sample tube shown held within part of an SMS-format rack.

### DETAILED DESCRIPTION

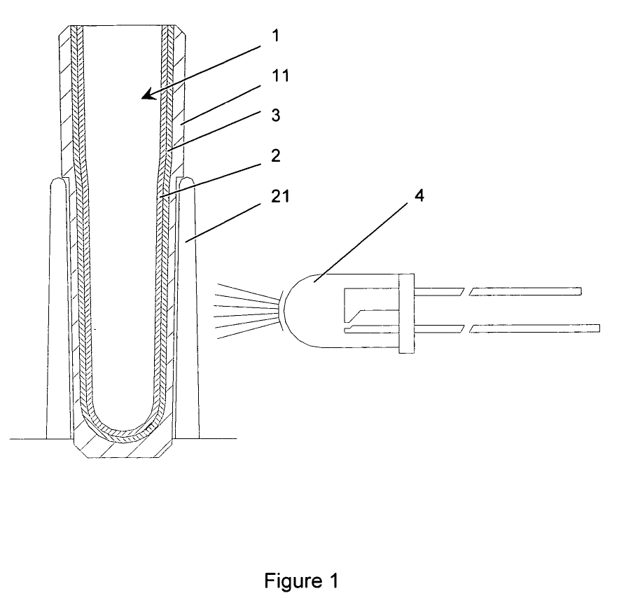

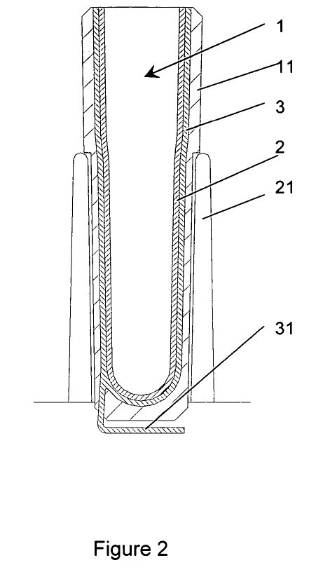

The sample tubes 1 shown in FIGS. 1 and 2 are based on a conventional PicoTube™ designed by The Automation Partnership Limited and manufactured and marketed by Matrix Technologies Corporation and the walls 11 of the tube are formed from polypropylene.

An aluminium coating 3 is first applied to the internal surfaces of the walls 11 by a sputtering process or plasma deposition and, thereafter, a silicone dioxide (glass) lining or coating 2 is similarly applied on the interior walls of the PicoTube™. Both the aluminium and the glass coatings may be, for example, 200 nm thick.

The aluminium coating 3 provides opaqueness to UV and visible light which may otherwise damage or affect a sample in an undesired manner. It also provides a means by which a sample within the sample tube 1 may, if required at particular stages of a chemical or biological process, be uniformly heated or the rate of heating or cooling controlled by means of say, an infra-red light-emitting diode (LED) 4 illuminated by a suitable electrical source (not shown), and radiating heat onto the metal coating 3 in the case of the FIG. 1 example.

In the example of FIG. 2, a tag 31, which extends through the wall 11 of the sample tube into engagement with the metal coating 3, may be used for the direct application of heat to the coating 3 conducted through the tag 31.

The glass coating or layer 2, preferably also provided by a sputtering or plasma deposition process, provides suitable chemical resistance to fluid compounds within the sample tube whilst also preventing gaseous exchange between the polypropylene walls 11 of the sample tube 1 and the sample within.

The sample tube 1, in both cases, is shown held between the corresponding supporting walls 21 of an SBS format rack.

1. A sample tube for insertion, in use, into an SBS format or similar rack, the sample tube comprising:
a polypropylene body;
a metallic coating on the internal surface of the tube; and
a glass coating or lining layer bonded to the metal coating.

2. The sample tube of claim 1, wherein the metal coating is aluminium.

3. The sample tube of claim 1, wherein the glass is opaque.

4. The sample tube of claim 1, wherein the glass is amber.

5. The sample tube of claim 1, further including a metal tag connected to or integrally formed with the metal coating and extending through the wall of the sample tube to the exterior.

6. A chemical or biological process using a sample tube according to claim 1, wherein a chemical or biological sample is disposed in the sample tube and heat is applied to the tube to control either the rate of heating the sample or to slow the rate of cooling of the sample when the tube is being heated or cooled respectively.

7. A chemical or biological process according to claim 6, wherein the sample tube is pre-heated by applying heat to the metal coating before a sample is inserted into the tube.

8. A method of manufacturing a sample tube according to claim 1, wherein the metal coating and/or the glass lining is/are provided by a sputtering process.

9. A method of manufacturing a sample tube according to claim 1, wherein the metal coating and/or the glass lining is/are provided by a plasma deposition process.
